(19) United States
(12) Patent Application Publication
(10) Pub. No.: US 2023/0021243 A1
(43) Pub. Date: Jan. 19, 2023

(54) SYSTEM AND METHOD FOR TEACHING SMART DEVICES TO RECOGNIZE AUDIO AND VISUAL EVENTS

(71) Applicant: ARRIS Enterprises LLC, Suwanee, GA (US)

(72) Inventors: Christopher Robert BOYD, Chalfont, PA (US); Albert F. ELCOCK, West Chester, PA (US); Christopher S. DELSORDO, Souderton, PA (US)

(73) Assignee: ARRIS Enterprises LLC, Suwanee, GA (US)

(21) Appl. No.: 17/724,807

(22) Filed: Apr. 20, 2022

Related U.S. Application Data
(60) Provisional application No. 63/221,123, filed on Jul. 13, 2021.

(51) Int. Cl. H04L 12/28; H04N 5/222; G06F 3/16; G06V 20/00

(52) U.S. Cl. CPC H04L 12/2803; H04N 5/222; G06F 3/16; G06V 20/35; H04L 2012/2841

(57) ABSTRACT

Exemplary embodiments are directed to a method and apparatus for training a smart device to recognize events in an indoor or outdoor venue. The smart device can execute program code for generating a specialized user interface. The smart device can record a target event in the venue or control another smart device to record the target event. The smart device can process the recording of the target event to generate an event signature. A unique tag for the recorded event can be generated, and the event signature and the unique tag can be transmitted to cloud storage. The smart device can receive event recordings from other smart devices in the venue and compare the event recordings to the event signatures in cloud storage. The smart device can generate at least one user or device prompt regarding the target event when the event recording matches an event signature.

### FIELD

The present disclosure is related to training a smart device to recognize events in a venue, and particularly, to recognize events associated with non-smart devices or machines.

### BACKGROUND

Voice control solutions are being integrated into many consumer products. These technologies bring an ability to execute “smart routines” upon recognition of recorded voice commands which provide enhanced features to these devices. A popular example of a voice control solution in the home includes a smart assistant. These devices are typically stationary and are placed in a preferred location. With the emergence of smart devices and smart appliances, smart assistants can be connected to control and monitor the status of a smart home environment and provide a status report to a consumer. Many homes do not have a complete smart environment, where at least all appliances are connected to and/or controlled through a voice control solution. Instead, these homes include a mixture of smart and non-intelligent (i.e., non-smart) devices or appliances, which cannot be remotely polled for status or remotely controlled through a wireless network.

The use of smart devices has been expanded to industrial environments as well. For example, the industrial internet of things (HOT) refers to interconnected sensors, instruments, and other devices networked together with computers to perform industrial applications and/or operations. IIOT is currently used in manufacturing and energy management. As with a home environment, a manufacturing or industrial entity may find benefit in converting its control and monitoring systems to IIOT platform, but may lack the financial resources or lack an urgent need to implement a complete conversion. The conversion may occur in stages such that the entity may use a combination of smart and non-smart devices and/or machinery. These circumstances could also occur in various military or commercial operations conducted in both indoor and outdoor environments, where smart and non-smart device can be used in combination to perform a desired task, activity, or mission.

### SUMMARY

An exemplary method is disclosed comprising: executing, by a processor of a consumer premise device, program code for generating a user interface; the processor performing the operations of: recording, by the user interface of the consumer premise device, a target event in an area of interest within a premise; and generating, by the user interface of the consumer premise device, a unique tag for the recorded event; transmitting, via a communication device of the consumer premise device, the recorded event and the unique tag to cloud storage; and generating, by the user interface of the smart consumer premise device, at least one user or device prompt in response to detection of the target event within the premise.

An exemplary apparatus is disclosed, comprising: memory storing program code for generating an interface; a processor configured to: execute the program code and generate the interface; record, by the interface, a target event in an area of interest within a premise; and generate, by the interface, a unique tag for the recorded event; a communication device configured to transmit the recorded event and the unique tag to cloud storage; and the processing device further configured to generate at least one user or device prompt in response to detection of the target event within the premise.

An exemplary computer readable medium storing program code for recognizing an event recognition interface is disclosed, the program code causing a processing device to: generate a user interface; record, by the user interface, a target event in an area of interest within a customer premise; generate, by the user interface, a unique tag for the recorded event; transmit the recorded event and the unique tag to cloud storage; and generate at least one user or device prompt in response to detection of the target event within the premise.

An exemplary apparatus is disclosed, comprising: memory storing program code for generating an interface; a processor configured to: record an audio or visual signal generated by a non-smart device in an outdoor venue; process the recorded signal to generate a signature of a target event; generate a unique tag for the signature of the target event; and a communication device configured to transmit the signature to cloud storage; and the processing device is further configured to generate at least one user or device prompt in response to a recognized target event based on an event recording of at least one other smart device monitoring the outdoor venue occupied by the non-smart device.

An exemplary method is disclosed comprising: executing, by a processor of a smart device, program code for generating a user interface; the processor performing the operations of: recording an audio or visual signal generated by a non-smart device in an indoor or outdoor venue; processing the recorded signal to generate a signature of a target event; storing the recorded signal with a corresponding unique tag in cloud storage; and generating at least one user or device prompt, when the signature of the target event is detected by at least one other smart device monitoring the indoor or outdoor venue occupied by the non-smart device.

An exemplary method is disclosed comprising: executing, by a processor of a first smart device, program code for generating a user interface; the processor performing the operations of: generating, by the user interface of the first smart device, one or more command signals for controlling another smart device to record a target event in an outdoor venue; receiving, by a communication interface of the first smart device, a recorded signal of the target event from the other smart device; processing, by the user interface of the first smart device, the recorded signal to generate an event signature of the target event; generating, by the user interface of the first smart device, a unique tag for the event signature; transmitting, by the communication device of the first smart device, the event signature to cloud storage; receiving, by the communication device of the first smart device, another recorded signal from the other smart device in the outdoor venue; comparing, via the user interface of the first smart device, the other recorded signal to one or more event signatures in cloud storage; and generating, by the user interface of the first smart device, at least one user or device prompt concerning a recognized target event when the recorded signal matches one of the one or more event signatures in cloud storage.

An exemplary non-transitory computer readable medium storing program code for generating a user interface is disclosed, the program code causing a processor of a smart device to: generate, by the user interface of the smart device, one or more command signals for controlling another smart device to record a target event in an outdoor venue; receive, by a communication interface of the smart device, a recorded signal of the target event from the other smart device; process, by the user interface of the smart device, the recorded signal to generate an event signature of the target event; generate, by the user interface of the smart device, a unique tag for the event signature; transmit, by the communication device of the smart device, the event signature to cloud storage; receive, by the communication device of the smart device, another recorded signal from the other smart device in the outdoor venue; compare, via the user interface of the smart device, the other recorded signal to one or more event signatures in cloud storage; and generate, by the user interface of the smart device, at least one user or device prompt concerning a recognized target event when the recorded signal matches one of the one or more event signatures in cloud storage.

An exemplary non-transitory computer readable medium storing program code for generating a user interface is disclosed, the program code causing a processor of a smart device to: record an audio or visual signal generated by a non-smart device in an indoor or outdoor venue; process the recorded signal to generate a signature of a target event; store the recorded signal with a corresponding unique tag in cloud storage; and generate at least one user or device prompt, when the signature of the target event is detected by at least one other smart device monitoring the indoor or outdoor venue occupied by the non-smart device.

### BRIEF DESCRIPTION OF THE DRAWINGS

FIGS. 1A and 1B illustrate systems for training a smart assistant in accordance with an exemplary embodiment of the present disclosure.

FIG. 2 illustrates a smart assistant configured to be trained in accordance with an exemplary embodiment of the present disclosure.

FIG. 3 illustrates a method for obtaining an event signature in accordance with an exemplary embodiment.

FIG. 4 illustrates a method for training a computing device to record an event signature in accordance with an exemplary embodiment of the present disclosure.

FIG. 5 illustrates a hardware configuration in accordance with an exemplary embodiment of the present disclosure.

### DETAILED DESCRIPTION

Exemplary embodiments of the present disclosure are directed to training a smart assistant to execute smart routines based on the recognition of specific audio sounds or even visual events. For example, the device with the smart assistant technology can be trained to recognize sound (whether within human hearing or otherwise, also referred to as audio herein) and/or light events (whether visible to humans or not, whether a visual signal, an image or moving images and/or video, also referred to as visual events herein) in an indoor or outdoor venue or environment. An indoor venue or environment can include a home, premise, office building, warehouse, factory, power plant, manufacturing facility, construction site, stadium, vehicle (industrial, commercial, or personal), or other suitable enclosed or partially enclosed space as desired. An outdoor venue or environment can include a land site, water site, or site in air space such as a mountainous region, a valley, plain, field, yard, canyon, cavern, an ocean, sea, lake, river, stream, or any other suitable location or environment where control or monitoring operations/activities could occur, would be needed, or would otherwise be useful. Coupling the ability of recognizing specific audio and visual events into specialized devices would enhance the capabilities of using non-smart devices and open up key areas in automation. That is, having smart devices monitor, recognize and react to sound and images resulting from actions of non-smart devices can cause reactions but humans and smart devices that would be present in smart devices to effectively extend smart device functionality to non-smart devices.

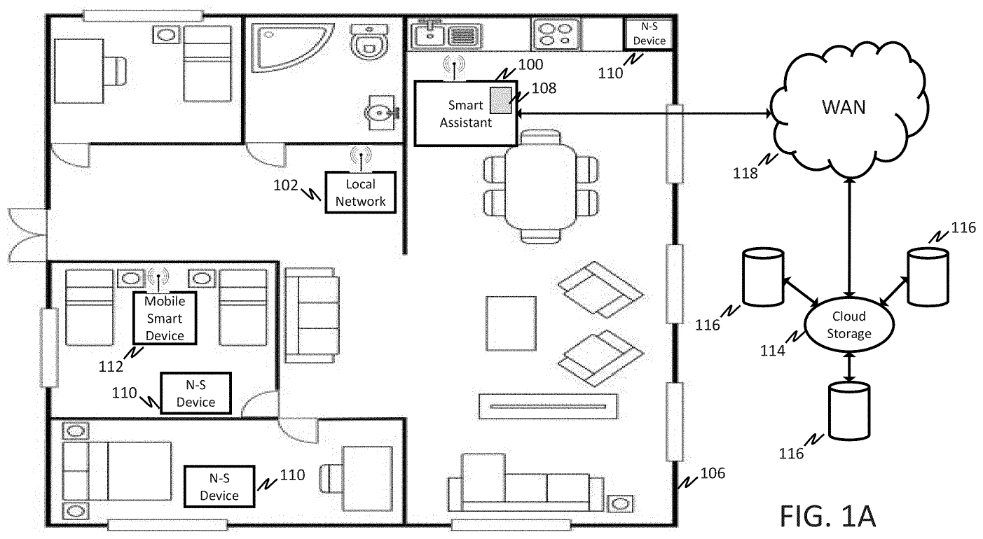

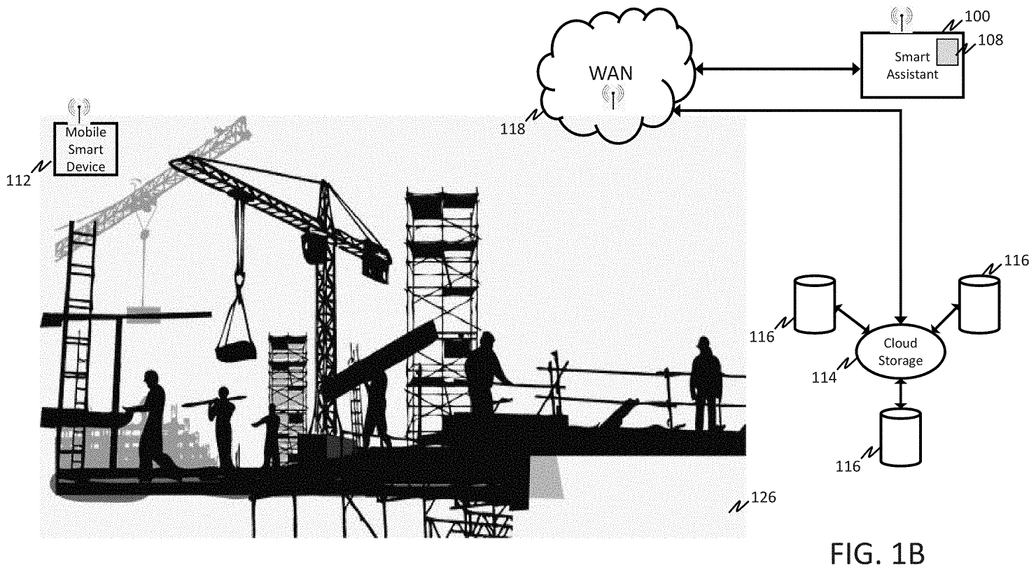

FIGS. 1A and 1B illustrate systems for training a smart assistant in accordance with an exemplary embodiment of the present disclosure. As shown in FIG. 1A, the system can be implemented in an indoor venue such as a home or premise. The system can include a computing device 100, a network 102, and a plurality of smart or intelligent devices 104 connected to the network 102. The computing device 100 can be a stationary device, which is disposed in a specified location (e.g., a room, specific location with in a room, global positioning system (GPC) coordinates, or nearly any area in which the smart device can monitor or detect sound and/or light effects on non-smart devices) in a venue 106 (e.g., home, office, or nearly any indoor or outdoor environment in which smart and non-smart devices might exist) for a time period at least. According to an exemplary embodiment, the computing device 100 can be a smart device, such as a smart assistant, configured for operation in the venue 106. Such operation can include monitoring an area or location within the venue occupied by one or more non-smart devices, generate one or more signals in response to events associated with the one or more non-smart devices, and respond to user requests, or status signals received from one or more smart or non-smart devices located in the venue. Furthermore, the response to the events associated with the non-smart devices can include generating at least one user or device prompt. The user or device prompt can include providing notification to a user that an event has occurred. For example, the computing device 100 can generate a signal which provides generic or specific sound and/or visual notification which corresponds to a recognized target event. According to an exemplary embodiment, the user or device prompts can be pushed over the network 102 to one or more registered devices (e.g., mobile phone, tablet, computer, smart watch, etc.) identified by a user. According to exemplary embodiments of the present disclosure, the computing device 100 can be configured to include an event recognition interface (ERI) 108 for recording target events, generating signatures of the target events, and generating tags for the target events (e.g., recognizes sound and/or visual effects or patterns of such effects of non-smart devices) associated with non-smart devices in the venue 106.

The network 102 can include one or more of a local area network (LAN), a wide area network (WAN), personal area network (PAN), a campus area network (CAN), a metropolitan area network (MAN), an enterprise private network, (EPN) a virtual private network (VPN), or any other suitable configuration as desired. The network 102 can be configured to support both wired and wireless connections between devices where appropriate.

As shown in FIG. 1B, the system can be implemented in an outdoor venue 126 such as a construction or manufacturing site. The system can include many of the same components used in the indoor space of FIG. 1A. In this implementation, the mobile or stationary smart device 102 can be drone or land-based remote controlled/robotic device. The mobile smart device 102 can be configured to communicate with the computing device 100 (e.g., smart device, or smart assistant) over the network 102, which in this case can be a WAN, EPN, VPN or other suitable platform as desired. The computing device 100 can be configured to include an event recognition interface (ERI), which enables a signature for a target event to be generated and recognized by the computing device 100. The target event being associated with a non-smart device (e.g., machine) in the outdoor venue.

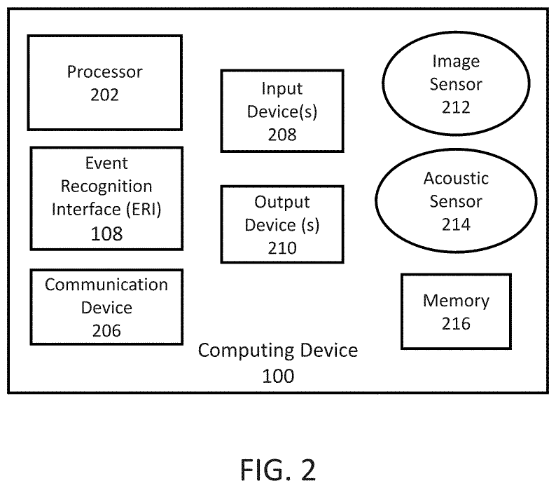

FIG. 2 illustrates a computing device 200 configured with an ERI in accordance with an exemplary embodiment of the present disclosure. As shown in FIG. 2, the computing device 200 can include a processor 202, the ERI 108, a communication device 206, an input device 208, an output device 210, an image sensor (e.g., analog or digital camera, camera phone, webcam, radar, sonar, or any other suitable imaging device as desired) 212, a sound sensor (e.g., microphone, acoustic sensor, or any suitable sensing device as desired, which can convert sound or pressure waves to an electrical signal) 214, and memory 216. The processor 202 can be configured to execute program code for performing the command and control operations for the computing device 200. The memory 216 can store the program code executed by the processor 202 and other components of the computing device 200. For example, the processor can execute program code stored in memory 216 for generating the ERI 108. The memory 216 can also store data resulting from the various operations performed by the computing device 200.

The ERI 108 provides the features and functionality for recording and classifying a recording (light, e.g., image (still or video) and/or sound) of an event. The recording can be used by the smart assistant 100 to generate an event signature which is used to recognize the event and execute a smart routine in response to the event. According to exemplary embodiments of the present disclosure, the event can be associated with a non-smart device or component 110 within the premise 106. In the context of the present disclosure, a non-smart device or component 110 can include an appliance or device which is not capable of and/or disabled from connecting to a communication network, such as the network 102, and/or is not capable of and/or disabled from wired or wireless communication with a smart device 104. Examples of non-smart devices or component can include, a Heating, Ventilation, and Air Conditioning (HVAC) system, a ceiling fan, a convection or regular oven, a microwave oven, a cook top stove, a vacuum cleaner, a garage door, a toilet, a faucet, a mechanical tool or mechanism, a lever, an engine, or any other suitable component as desired in the context of the invention. The ERI 108 can generate one or more audio and/or visual prompts which guide the user through the process of obtaining the recording and generating the signature of a target event. The prompts can be presented to the user through one or more output devices 210 (e.g., display device, speakers, etc.) of the computing device 200 or peripheral components. For example, the ERI 108 can generate a graphical interface including informational, selectable, and/or activatable banners and buttons, as well as data entry fields. The user can activate the recording by using one or more input devices 208 of the computing device. For example, the one or more input devices 208 can include virtual button of a touch screen display device or physical buttons which can be activated or depressed in response to a prompt. Furthermore, the input devices 208 can also include the acoustic sensor 214 or a separate microphone which the user can use to input voice commands or responses to an ERI prompt.

According to an exemplary embodiment, the ERI 108 can be configured to have a predetermined time period within which a sound and/or light, image and/or video associated with the target event can be captured after the recording is initiated. The time period can be a specified length such as 3 seconds, 6 seconds, 9 seconds, 12 seconds, or any other time period as appropriate or as specified by the user. According to another exemplary embodiment, once the recording is initiated, the ERI 108 can generate and/or display a user prompt for terminating the recording. For example, the recording termination prompt can be displayed upon the initiation of the recording interval. In another example, the recording termination prompt can be displayed after a predetermined time period has elapsed.

As shown in FIG. 2, the teaching assistant 102 can include an image sensor 212 that can detect light, light patterns, images and/or moving images depending on application and an acoustic sensor 214 that can detect audible or inaudible sound depending on application, for obtaining data to be used a signature of the target event. The acoustic sensor 214 can be configured to capture sound generated by a non-smart device 110 during an operating mode within the customer premise 106. The image sensor 212 can be configured to capture still and/or video images associated with the non-smart device 110 within the premise. According to an exemplary embodiment, the processor 202 can be configured to repeat the recording of the target event multiple times. After capturing each recording, the processor 202 can perform one or more processing operations on the sound and/or light components of the signal including one or more known signal processing operations such as filtering. The multiple recordings can allow the target event to be recognized under various conditions including background noise (e.g., white noise) or other signal interference generally caused by other sources of electromagnetic signals within the area of the recording. After processing the recorded event data (e.g., target event), the ERI 108 can generate a unique tag for the recorded data (e.g., target event). The unique tag can serve as an identifier for the sound or video recording of the event. The communication device 206 can transmit the recorded target event and the unique tag over the local network 102 to cloud storage 114. The cloud storage 114 can include a plurality of physical storage devices 116 accessible over a communication network, such as a wide area network (WAN) 118. The plurality of storage devices 116 can be owned and managed or controlled by a third-party host. Once the unique tag is stored, it can be accessed by the smart assistant to generate a smart routine based on the identified event. The smart routine can include a reference to one or more unique tags stored in the cloud storage 114 to generate a response to an event generated by the operation of a non-smart device 110 within the premise 106.

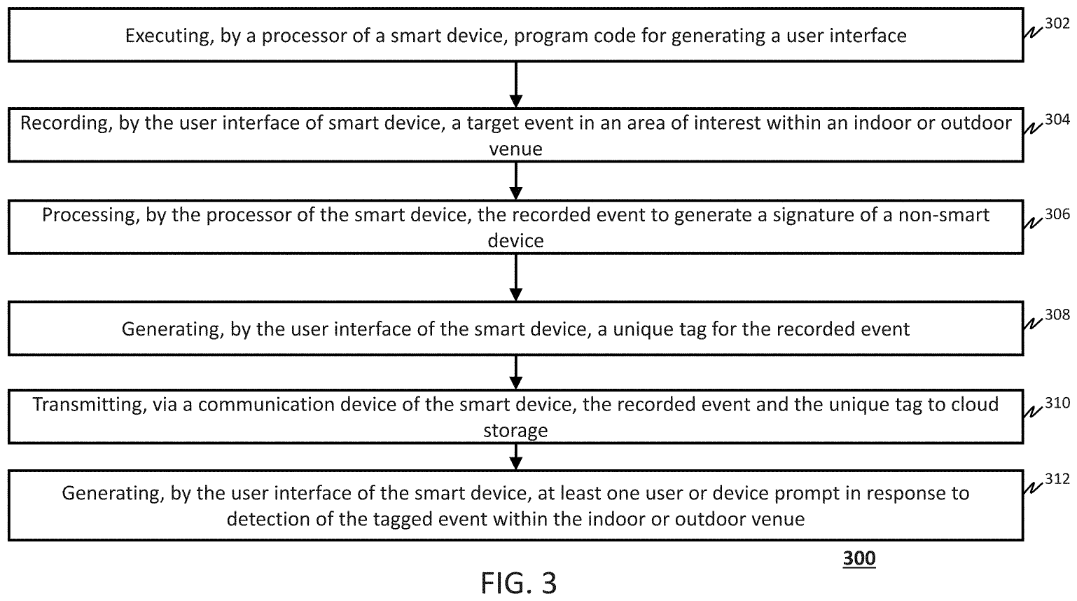

FIG. 3 illustrates a method for generating an event signature in accordance with an exemplary embodiment.

In a step 302, the processor 202 can access the memory 212 for obtaining and executing the program code for generating the ERI 108. After generating the ERI 108, the processor performs the step of recording a target event by capturing an audio or visual signal, or image of the target event in an area of interest within the venue 106 using at least an image sensor 212 and/or an acoustic sensor 214 (Step 304). For example, the ERI 108 can generate one or more prompts through an output device 210 of the computing device 200 which instruct a user to initiate the recording of the target event. The ERI 108 receives one or more user inputs via an input device 208 of the computing device 200 and controls the recording of the target event based on one or more user inputs for starting and/or stopping the recording. The processor 202 can process the captured audio or visual signal of the captured event to generate a signature of the target event (Step 308). The ERI 108 can generate a unique tag for the recorded target event (Step 306) and the recorded target event and the unique tag are transmitted to cloud storage (Step 310). In Step 312, the processor 202 of the computing device 200 can generate at least one user or device prompt in response to detection of the target event within the premise 106. As already discussed, the processor 202 can send a signal to notify the user that a target event has occurred. The notification can be output on the computing device 100 associated with the processor 202 or the signal can be sent over the network 102 to output the notification on one or more registered devices of the user.

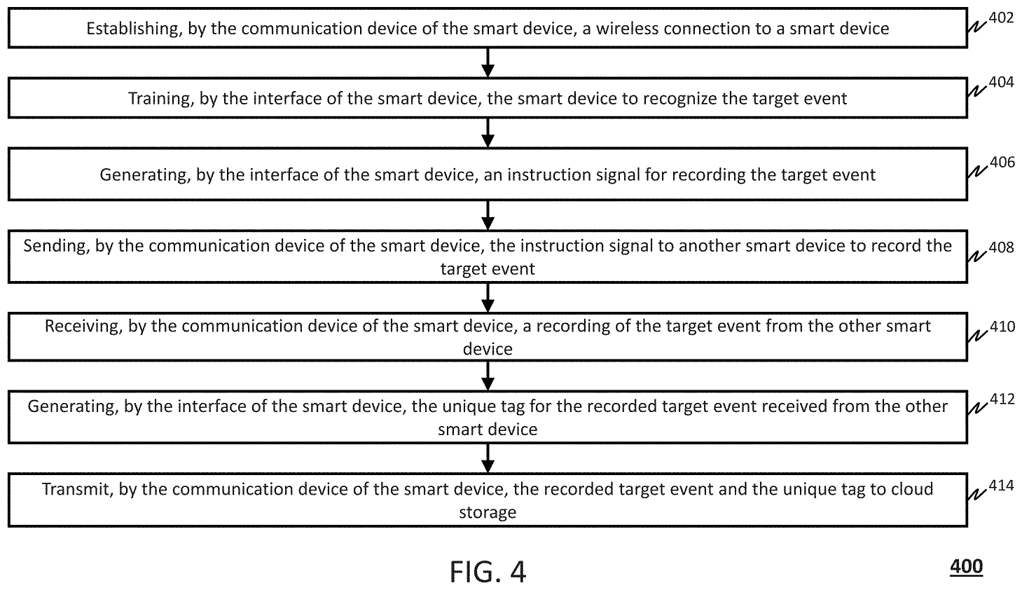

According to an exemplary embodiment, the ERI 108 can allow the computing device 200 to leverage the capabilities of remote smart devices or intelligent devices to obtain the recordings or signatures of events within the premise. FIG. 4 illustrates a method 400 for training a computing device to record an event signature in accordance with an exemplary embodiment of the present disclosure.

As shown in FIG. 4, the computing device 100 can establish, by the communication device 206, a wireless connection to a smart device 112 within the venue 106 over the network 102 (Step 402). Once the connection with the smart device 112 is established, the computing device 200 can use the ERI 108 to train the smart device 112 to recognize a target event by obtaining the event signature (Step 404). For example, the computing device 100 can communicate with the smart device 112 to obtain data detailing the available monitoring capabilities. The data can include information identifying a type of sensor (acoustic 214, image 212, etc.), a location of the smart device 112 within the premise 106, a location of the non-smart device 110 within the premise 106, or any other suitable information as desired. The location (e.g., position) data can be determined based on a proximity of the smart or non-smart device to other smart devices within the venue. According to one exemplary embodiment, localization techniques in an indoor venue can be based on positioning with respect to wireless access points can measure the intensity of the received signal (e.g., received signal strength indication (RSSI)) based on the identity and location of the wireless access points determined from the associated service set identifier (SSID) or media access control (MAC) address. According to an exemplary embodiment, location determination techniques in an indoor and/or outdoor venue can be based on geolocation and time data generated by the global positioning system (GPS). It should be understood that the location data could include any other data suitable for indicating a position or location as desired.

Furthermore, the smart device data can indicate whether the smart device 112 is stationary or mobile. According to an exemplary embodiment, the mobile smart device 112 can be a robotic device, a drone capable of moving over land, air, and/or water, or a portable device that can be carried by or attached to a user or machine. Based on the monitoring capabilities of the smart device 112, in Step 406 the computing device 200 may generate an instruction signal for recording the target event and/or the signature of the target event. The instruction signals can include information such as a length of the current recording interval, and if the smart device is mobile, a position to which the smart device should move to within the venue or in relation to the non-smart device 110 to obtain the current recording. For example, the ERI 108 can generate one or more prompts for instructing the use to move the smart device 112 to a new position relative to the non-smart device 110. According to an exemplary embodiment, the instruction signal can also specify a number of recording intervals to be executed for capturing the event signature, and identify one or a combination of the available sensors to be used during the one or more recording intervals. Using the communication device 206, the computing device 100 sends the instruction signal to the smart device 112 over the local network 102 (Step 408). The computing device 100 can send one or more instruction signals for recording the target event or the signature of the target event over each recording interval.

In step 410, the computing device 200 receives the one or more recordings of the target event from the smart device 104 and processes each recording to further enhance recognition of the target event and generate an event signature. According to an exemplary embodiment, the processor 202 can be configured to perform one or more image processing and/or audio processing operations on the audio and/or image data included in the recordings. The operations can use include known processing techniques, such as image/audio analysis, image/audio filtering, image/audio enhancement, or any other techniques or processes as desired. The processor 202 can generate a unique tag for the recorded data received from the smart device 104 (Step 412). The unique tag can be generated automatically by the process or manually by receipt of input information from the user. For automatic generation, the processor 202 can execute program code for a neural network model which can be trained to create unique tags based on one or more of the non-smart device 110 associated with the target event and the location of the target event in the premise 106, among others. The communication device 206 can transmit the event signature and the unique tag of the recorded target event to cloud storage 114 over the WAN 118 (Step 414). Once the recorded target event is stored, it can be accessed by the computing device 100 to generate a smart routine for pushing notifications to registered devices of the user in response to detection of the target event.

Exemplary embodiments of the present disclosure can be used for devices that include both voice assistant technologies and web cam recording technologies. Based on the recorded event and the unique tag, a computing device 100 executing the ERI 108 can push a video feed or sound file to the cloud storage 114 as a visual and/or acoustic event for later use by a multitude of smart devices within the premise 106. A smart device 112, which can be mobile, can monitor the venue 106 or a specific area within the premise 106 by capturing current signature data (sound(s) or image(s)) related to the operation of a non-smart device 110. As the current data is captured, it is compared to event signatures in the cloud storage 114. The current data can be compared to event signatures associated with specific areas of the premise 106 as appropriate. If a match is found, the smart device 112 is determined to have recognized the event and generates a user or device prompt, which indicates that a target event has occurred.

### Use Cases

According to one example, a user may want to be notified when their cat is eating. A computing device 100 executing the ERI 108 can also be configured with smart assistant technology. The ERI 204 can provide a voice assistant which includes an interface for starting and stopping a recording of the event. The interface would allow the recording of images associated with the visual event the “cat is eating”. Once the visual event is recorded, the ERI 108 can generate an interface for display to the user, which allows the recorded visual event to be tagged. This tag can be named so that it can be used as an identifier for the visual event in subsequent voice commands or smart routine. For example, the consumer tag can identify the event as “Alexa send Chris a text when the oven timer goes off”. The visual event and the associated tag are transmitted to the cloud storage 114. The operations performed by the ERI 108 provides added functionality to known smart assistant 100 and/or smart assistant technology for recording, tagging, and recognizing a previously recorded visual or acoustic event such as “the cat is eating.”

In another example, a smart routine is created to recognize when food is forgotten in a microwave. To generate the smart routine, the computing device 100 executes the ERI 108 to recognize the beep of a microwave indicating cook timer is finished and the opening and closing of the microwave door. When the microwave oven finishes its timed cooking interval and beep sounds, the computing device 100 (e.g., smart assistant) recognizes the beep and executes an associated smart routine. The computing device 100 initiates a timer which defines an “x” minute threshold within which the computing device 100 monitors the area for the sound of the opening and closing of the microwave door. If after “x” minutes the computing device 100 does not recognize the sound of microwave door opening and closing, a notification is pushed to all targeted devices of the user indicating that the microwave's cooking interval has ended.

In yet another example, a smart routine is created to recognize when the refrigerator door is opened after a specific time. To generate the smart routine, the computing device 100 (e.g., smart assistant) executes the ERI 204 to recognize the sound of the refrigerator door opening and/or closing and/or the sound of the refrigerator motor when the refrigerator door is open. When the refrigerator door is opened after the specified time (e.g., 11:59 pm), the computing device 100 recognizes the event and executes an associated smart routine. In executing the smart routine, the computing device 100 turns on the lights in the kitchen and pushes a notification to the targeted mobile devices, which indicates midnight snacking is taking place.

In yet another example, a smart routine can be created to recognize when a burner on a cooktop stove has been left on. To generate the smart routine, the computing device 100 executes the ERI 204 to recognize light or color at one or more locations in an image. The locations in the image correspond to the locations of each burner of the cooktop stove.

According to an example, a smart routine can be created to monitor the operation of a mechanism or machine in a field or yard. The computing device 100 can be drone capable of movement through air or land, or can be a device carried or attached to a person. The computing device 100 can execute the ERI to recognize an operating characteristic, operating mode, or operating event associated with the mechanism or machine. Once the event is recognized the computing device 100 can push a notification to the appropriate devices to as operator or system notifications of the machine's operating status or of a start or end of a particular phase in an industrial operation or activity.

### Hardware Configuration

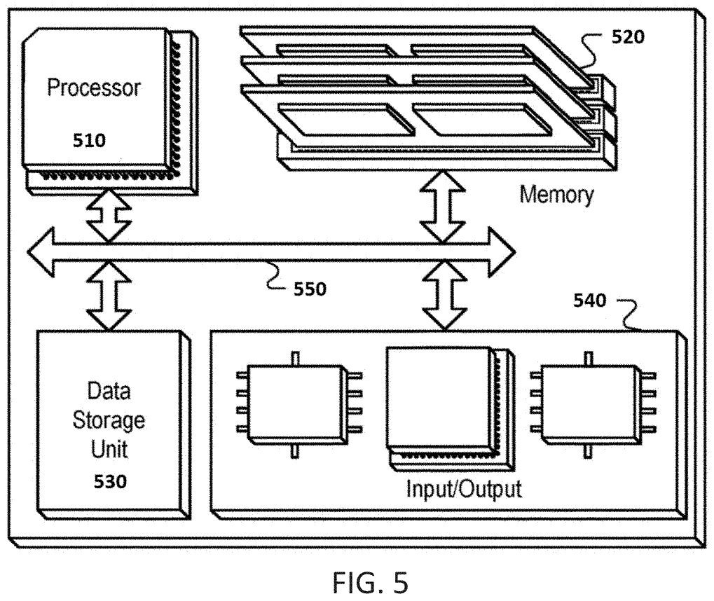

FIG. 5 is a block diagram of a hardware configuration 500 of a computing device (e.g., smart device) in accordance with an exemplary embodiment of the present disclosure. It should be understood that exemplary embodiments of the present disclosure can be implemented using one or more hardware configurations 500 having any combination of features, functions, and/or components described in the discussion that follows and connected to communicate over a network. For example, the computing device can include a customer premise device such as a smart television, a set-top box, a smart media device, a smart assistant, and/or any other suitable device as desired.

The hardware configuration 500 can include a processor (e.g., processing device) 510, a memory (e.g., memory device) 520, a data storage device 530, and an input/output device 540. Each of the components 510, 520, 530, and 540 can be interconnected using a system bus 550. The processor 510 can be capable of processing instructions for execution within the hardware configuration 500. In one implementation, the processor 510 can be a single-threaded processor. In another implementation, the processor 510 can be a multi-threaded processor. The processor 510 can be capable of processing instructions stored in the memory 520 or on the storage device 530.

The memory 520 can store information within the hardware configuration 500. In one implementation, the memory 520 can be a computer-readable medium. In one implementation, the memory 520 can be a volatile memory unit. In another implementation, the memory 520 can be a non-volatile memory unit.

In some implementations, the storage device 530 can be capable of providing mass storage for the hardware configuration 500. In one implementation, the storage device 530 can be a computer-readable medium. In various different implementations, the storage device 530 can include, for example, a hard disk device, an optical disk device, flash memory or some other large capacity storage device. In other implementations, the storage device 530 can be a device external to the hardware configuration 500.

The input/output device 540 provides input/output operations for the hardware configuration 500. In embodiments, the input/output device 540 can include one or more of a network interface device (e.g., an Ethernet card), a serial communication device (e.g., an RS-232 port), one or more universal serial bus (USB) interfaces (e.g., a USB 2.0 port), one or more wireless interface devices (e.g., an 802.11 card), and/or one or more interfaces for communicating with other smart devices 112 and/or cloud storage 114 over the WAN 118. In exemplary embodiments, the input/output device 540 can include driver devices configured to send communications to, and receive communications from one or more networks (e.g., subscriber network, WAN, local network, etc.).

According to exemplary embodiments, the functional operations described herein can be provided in digital electronic circuitry, or in computer software, firmware, or hardware, including the structures disclosed in this specification and their structural equivalents, or in combinations of one or more of them. Some embodiments of the subject matter of this disclosure, and components thereof, can be realized by software instructions that upon execution cause one or more processing devices to carry out processes and functions described above. Further embodiments of the subject matter described in this specification can be implemented as one or more computer program products, i.e., one or more modules of computer program instructions encoded on a tangible program carrier, which when executed control the operation of the data processing apparatus.

One or more exemplary computer programs (also known as a program, software, software application, script, or code) for executing the functions of the exemplary embodiments disclosed herein, can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communication network.

In some embodiments, the processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. According to exemplary embodiments, an apparatus or device embodying the invention may be in the form of a gateway, an access point, a set-top box or other standalone device, or may be incorporated in a television or other content playing apparatus, or other device, and the scope of the present invention is not intended to be limited with respect to such forms.

Components of some embodiments may be implemented as Integrated Circuits (IC), Application-Specific Integrated Circuits (ASIC), or Large Scale Integrated circuits (LSI), system LSI, super LSI, or ultra LSI components. Each of the processing units can be many single-function components, or can be one component integrated using the technologies described above. Components may also be implemented as a specifically programmed general purpose processor, CPU, a specialized microprocessor such as Digital Signal Processor that can be directed by program instructions, a Field Programmable Gate Array (FPGA) that can be programmed after manufacturing, or a reconfigurable processor. Some or all of the functions may be implemented by such a processor while some or all of the functions may be implemented by circuitry in any of the forms discussed above.

It is also contemplated that implementations and components of embodiments can be done with any newly arising technology that may replace any of the above implementation technologies.

While this specification contains many specific implementation details, these should not be construed as limitations on the scope of any invention or of what may be claimed, but rather as descriptions of features, that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination in some cases can be excised from the combination, and the claimed combination may be directed to a subcombination or variation of a subcombination.

Similarly, where operations are depicted in the drawings in a particular order, this should not be understood as requiring that such operations be performed in the particular order shown or in sequential order unless otherwise noted, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

While the preceding discussion used Wi-Fi and/or Ethernet communication protocols as illustrative examples, in other embodiments a wide variety of communication protocols and, more generally, adaptive balancing techniques may be used. Thus, the adaptive balancing technique may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the adaptive balancing technique may be implemented using program instructions, operating system (such as a driver for interface circuit) or in firmware in an interface circuit. Alternatively or additionally, at least some of the operations in the adaptive balancing technique may be implemented in a physical layer, such as hardware in an interface circuit.

The preceding description may refer to ‘some embodiments.’ which describes a subset of all of the possible embodiments, but does not always specify the same subset of embodiments. Moreover, note that numerical values in the preceding embodiments are illustrative examples of some embodiments. In other embodiments of the communication technique, different numerical values may be used.

The foregoing description is intended to enable any person skilled in the art to make and use the disclosure and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

Having described the invention in detail, it will be understood that such detail need not be strictly adhered to, but that additional changes and modifications may suggest themselves to one skilled in the art.

What is claimed is:

1. A method comprising:
executing, by a processor of a consumer premise device, program code for generating a user interface;
the processor performing the operations of:
recording, by the user interface of the consumer premise device, a target event in an area of interest within a premise; and
generating, by the user interface of the consumer premise device, a unique tag for the recorded event;
transmitting, via a communication device of the consumer premise device, the recorded event to cloud storage; and
generating, by the user interface of the consumer premise device, at least one user or device prompt in response to detection of the target event within the premise.

2. The method of claim 1, comprising:
receiving, by the user interface of the consumer premise device, one or more user inputs; and
controlling, by the user interface of the consumer premise device, the recording of the target event based on the one or more user inputs.

3. The method of claim 1, wherein recording the target event comprises:
capturing, via an audio sensor of the consumer premise device, audio signals occurring during the target event.

4. The method of claim 1, wherein recording the target event comprises:
capturing, via an image sensor of the consumer premise device, image signals occurring during the target event.

5. The method of claim 1, wherein the program code includes a neural network model, the method comprising:
establishing, by the communication device of the consumer premise device, a wireless connection to a smart device within the premise;
training, by the user interface of the consumer premise device, the smart device to recognize the target event;
generating, by the user interface of the consumer premise device, an instruction signal for recording the target event;
sending, by the communication device of the consumer premise device, the instruction signal to the smart device to record the target event;
receiving, by the communication device of the consumer premise device, a recording of the target event from the smart device;
generating, by the user interface of the consumer premise device, the unique tag for the recorded target event received from the smart device; and
generating, by the user interface of the consumer premise device, the at least one user or device prompt in response to detection of the target event by the smart device within the premise.

6. The method of claim 5, wherein the smart device is a mobile device.

7. The method of claim 1, further comprising:
repeating the recording of the target event multiple times; and
processing, by the user interface of the consumer premise device, the multiple recordings of the target event to accurately recognize the target event.

8. An apparatus, comprising:
memory storing program code for generating an interface;
a processor configured to:
execute the program code and generate the interface;
record, by the interface, a target event in an area of interest within a premise; and
generate, by the interface, a unique tag for the recorded event;
a communication device configured to transmit the recorded event and the unique tag to cloud storage; and
the processor further configured to generate at least one user or device prompt, which is executed by the processor in response to detection of the target event within the premise.

9. The apparatus of claim 8, wherein:
the communication device is further configured to establish a wireless connection with a smart device within the premise;
the processor is further configured to:
train, by the interface, the smart device to capture the target event; and
generate, by the interface, an instruction signal for recording the target event;
the communication device is further configured to:
transmit the instruction signal to the smart device to record the target event; and
receive a recording of the target event from the smart device;
the processor is further configured to:
generate, by the interface, the unique tag for the recorded target event received from the smart device; and
generate, by the interface, the at least one user or device prompt in response to detection of the target event by the smart device within the premise.

10. The apparatus of claim 9, wherein training the smart device comprises:
training, by the interface, the smart device to capture audio signals in the area of interest during the target event.

11. The apparatus of claim 9, wherein training the smart device comprises:
training, by the interface, the smart device to capture image signals in the area of interest during the target event.

12. The apparatus of claim 9, wherein:
the communication device is further configured to receive location information of the smart device within the premise; and
the processor is further configured to select the at least one user or device prompt associated with a non-smart device within the premise based on the received location information.

13. A computer readable medium storing program code for generating an event recognition interface, the program code causing a processor of a consumer premise device to:
generate a user interface;
record, by the user interface, a target event in an area of interest within a premise;
generate, by the user interface, a unique tag for the recorded event;
transmit the recorded event to cloud storage; and
generate at least one user or device in response to detection of the target event within the premise.

14. A method comprising:
executing, by a processor of a smart device, program code for generating a user interface;
the processor performing the operations of:
recording an audio or visual signal generated by a non-smart device in an indoor or outdoor venue;
processing the recorded signal to generate a signature of a target event;
storing the recorded signal with a corresponding unique tag in cloud storage; and
generating at least one user or device prompt, when the signature of the target event is detected by at least one other smart device monitoring the indoor or outdoor venue occupied by the non-smart device.

15. The method of claim 14, comprising:
capturing, by the one or more sensing devices of the smart device at a later time, another audio or video signal associated with the non-smart device; and
comparing, by the processor of the smart device, the other audio or video signal to a plurality of target event signatures in the cloud storage, wherein the target event signatures are associated with the indoor or outdoor venue occupied by the non-smart device.

16. The method of claim 14, wherein the outdoor venue is located on land, water, or air space.

17. An apparatus, comprising:
memory storing program code for generating an interface;
a processor configured to:
record an audio or visual signal generated by a non-smart device in an outdoor venue;
process the recorded signal to generate a signature of a target event;
generate a unique tag for the signature of the target event; and
a communication device configured to transmit the signature to cloud storage; and
the processing device is further configured to generate at least one user or device prompt in response to a recognized target event based on an event recording of at least one other smart device monitoring the outdoor venue occupied by the non-smart device.

18. A method comprising:
executing, by a processor of a first smart device, program code for generating a user interface;
the processor performing the operations of:
generating, by the user interface of the first smart device, one or more command signals for controlling another smart device to record a target event in an outdoor venue;
receiving, by a communication interface of the first smart device, a recorded signal of the target event from the other smart device;
processing, by the user interface of the first smart device, the recorded signal to generate an event signature of the target event;
generating, by the user interface of the first smart device, a unique tag for the event signature;
transmitting, by the communication device of the first smart device, the event signature to cloud storage;
receiving, by the communication device of the first smart device, another recorded signal from the other smart device in the outdoor venue;
comparing, via the user interface of the first smart device, the other recorded signal to one or more event signatures in cloud storage; and
generating, by the user interface of the first smart device, at least one user or device prompt concerning a recognized target event when the recorded signal matches one of the one or more event signatures in cloud storage.

19. The method of claim 18, wherein the target event is associated with a machine or activity in the outdoor venue.

20. The method of claim 18, wherein the recorded signal is an audio or visual signal.

21. The method of claim 20, wherein the visual signal includes one or more still images or a video.

22. The method of claim 18, wherein controlling another smart device includes:
instructing, through the generated command signals, the other smart device to move to one or more positions in the outdoor venue relative to a machine or activity to be monitored.

23. The method of claim 18, wherein the program code includes a neural network model, the method comprising:
establishing, by the communication device of the first smart device, a wireless connection to the other smart device within the outdoor venue;
training, by the user interface of the first smart device, the other smart device to recognize the target event;
generating, by the user interface of the first smart device, one or more instruction signals for recording the target event;
sending, by the communication device of the first smart device, the one or more instruction signals to the other smart device to record the target event;
receiving, by the communication device of the first smart device, one or more recordings of the target event from the other smart device;
processing, by the user interface of the first smart device, the one or more recordings of the target event to generate the event signature;
generating, by the user interface of the first smart device, the unique tag for the event signature; and
sending, by the communication device of the first smart device, the event signature and the unique tag to cloud storage.

24. A non-transitory computer readable medium storing program code for generating a user interface, the program code causing a processor of a smart device to:
generate, by the user interface of the smart device, one or more command signals for controlling another smart device to record a target event in an outdoor venue;
receive, by a communication interface of the smart device, a recorded signal of the target event from the other smart device;
process, by the user interface of the smart device, the recorded signal to generate an event signature of the target event;
generate, by the user interface of the smart device, a unique tag for the event signature;
transmit, by the communication device of the smart device, the event signature to cloud storage;
receive, by the communication device of the smart device, another recorded signal from the other smart device in the outdoor venue;
compare, via the user interface of the smart device, the other recorded signal to one or more event signatures in cloud storage; and
generate, by the user interface of the smart device, at least one user or device prompt concerning a recognized target event when the recorded signal matches one of the one or more event signatures in cloud storage.

25. A non-transitory computer readable medium storing program code for generating a user interface, the program code causing a processor of a smart device to:
record an audio or visual signal generated by a non-smart device in an indoor or outdoor venue;
process the recorded signal to generate a signature of a target event;
store the recorded signal with a corresponding unique tag in cloud storage; and
generate at least one user or device prompt, when the signature of the target event is detected by at least one other smart device monitoring the indoor or outdoor venue occupied by the non-smart device.
